(19) United States
(12) Patent Application Publication
(10) Pub. No.: US 2013/0242765 A1
(43) Pub. Date: Sep. 19, 2013

(54) ERROR DETECTION

(71) Applicants: Keiichi KUBOTA, Weybridge (GB); Brian MARTIN, Farnham (GB)

(72) Inventors: Keiichi KUBOTA, Weybridge (GB); Brian MARTIN, Farnham (GB)

(73) Assignee: RENESAS MOBILE CORPORATION, TOKYO (JP)

(21) Appl. No.: 13/482,210

(22) Filed: May 29, 2012

(30) Foreign Application Priority Data
Mar. 18, 2012 (GB) 1204812.0

(51) Int. Cl. H04W 24/00; H04L 12/26

(52) U.S. Cl. 370/252

(57) ABSTRACT

Methods and apparatus for enabling ciphering error detection and recovery in a telecommunications network. Predetermined data is inserted into at least one radio link control service data unit at a network entity. The predetermined data has the same form as a packet data convergence protocol header. The at least one radio link control service data unit comprising the predetermined data is transmitted to a user equipment in the network. As a result, the user equipment is able to apply, on the basis of the predetermined data, either an unacknowledged mode radio link control ciphering error detection and recovery mechanism or a packet data convergence protocol ciphering error detection and recovery mechanism to the at least one radio link control service data unit.

### CROSS REFERENCE TO RELATED APPLICATION

This application claims the benefit under 35 U.S.C. §119(a) and 37 CFR 1.55 to UK patent application no. 1204812.0, filed on 18 Mar. 2012, the entire content of which is hereby incorporated by reference.

### TECHNICAL FIELD

The present invention relates to apparatus and methods for enabling ciphering error detection and recovery in a telecommunications network.

### BACKGROUND

In UMTS, IMS voice is normally served by the UM RLC bearer. The RLC transmitter ciphers user data, referred to as PDU, transmits it to the receiving RLC, which deciphers the PDU. If the receiving RLC fails to receive 127 consecutive RLC PDUs after the transmitter has sent 127 consecutive RLC PDUs, the receiving RLC will not increment its HFN value of COUNT-C, which results in a desynchronization of COUNT-C values between the RLC transmitter and the receiving RLC. This is referred to as a “security desynchronization” problem.

Two solutions have been proposed to address this problem, and both involve providing a mechanism that can be used to identify an error and subsequently reporting to the transmitter when an error has been detected.

A first solution is UM RLC ciphering error detection, where a receiving RLC checks if the LI field indicates a valid value, and if the receiving RLC detects invalid LI N times consecutively, then it detects an RLC unrecoverable error and reports the error to a RRC entity. The value N comprises a positive integer, for example 2.

An advantage of the UM RLC based solution is that the network does not need to configure a PDCP entity. A problem with the UM RLC based solution is that the NW may not send LIs with each and every UM RLC PDU and an alternative E-bit interpretation may lead to there not being any LI information in the UM RLC header. The network will therefore be forced to send the LI which will result in an overhead of 8 bits per PDU, which is the same overhead as the PDCP based solution. A further problem with the UM RLC based solution is that even if the LI is present in each PDU, there is a problem that the receiver RLC cannot always detect a ciphering error even when COUNT-C values are desynchronised between UE and NW because an incorrectly ciphered LI could indicate a valid value. This is because the LI can be considered “invalid” only when the LI indicates one of the reserved values or indicates a longer PDU size than the received RLC PDU (e.g. for the case that the received LI indicates 80 octet when the received RLC PDU size is 240 bits). In contrast, the PDCP header has only one valid value for PDU type field and PID field so the error detection performance of the PDCP based solution would tend to be better than the UM RLC based solution. A still further problem with the UM RLC based solution is that there is no UE capability, so the RNC is not sure whether a UE supports UM RLC ciphering error detection and recovery or not when the RNC receives a cell update message, so the RNC is not sure whether it can re-establish the IMS voice RB or not.

A second solution is PDCP ciphering error detection, where a receiving PDCP entity checks if the PDCP header fields (i.e. PDCP PDU type field and PID field) indicate valid values, and if the receiving PDCP entity detects invalid PDCP header field N times consecutively, then it detects a PDCP unrecoverable error and reports the error to a RRC entity. The value N comprises a positive integer, for example 2. This detection is performed on the basis of an “expected value” of the PDCP header.

An advantage of the PDCP based solution is that the solution has already been used for a CS voice over HSPA service and so vendors can re-use the existing implementation. However, a problem with the PDCP solution is that operators may not want to configure a PDCP entity for IMS voice. Further, in the event that a UM RLC receiver receives an RLC PDU with an invalid LI, the receiver cannot reassemble the data into one PDCP PDU; as a result, the receiver cannot send a PDCP PDU to the PDCP entity in the network.

For CSoHSPA, current 3GPP specifications specify that a UE automatically configures PDCP ciphering error detection at the PDCP layer.

In 3GPP TSG-RAN WG2 Meeting #77, Dresden, Germany, 6th-10 Feb. 2012, (documented as R2-120332), UM RLC ciphering error detection and recovery for IMS voice was discussed. Introduction of a new UE capability for UM RLC ciphering error detection and recovery for IMS voice was proposed. It was also proposed that RRC messages should be updated to explicitly configure UM RLC ciphering error detection and recovery for IMS voice RB.

There is therefore a need to provide improved ways of enabling ciphering error detection and recovery.

### SUMMARY

In accordance with first embodiments, there is a method of enabling ciphering error detection and recovery in a telecommunications network, the method comprising, at a network entity:

inserting predetermined data into at least one radio link control service data unit; and

transmitting the at least one radio link control service data unit comprising the predetermined data to a user equipment in the network,

whereby the user equipment is able to apply, on the basis of the predetermined data, either an unacknowledged mode radio link control ciphering error detection and recovery mechanism or a packet data convergence protocol ciphering error detection and recovery mechanism to the at least one radio link control service data unit.

In accordance with second embodiments, there is apparatus for use in enabling ciphering error detection and recovery in a telecommunications network, the apparatus comprising a processing system adapted to, at a network entity:

insert predetermined data into at least one radio link control service data unit; and

transmit the at least one radio link control service data unit comprising the predetermined data to a user equipment in the network,

whereby the user equipment is able to apply, on the basis of the predetermined data, either an unacknowledged mode radio link control ciphering error detection and recovery mechanism or a packet data convergence protocol ciphering error detection and recovery mechanism to the at least one radio link control service data unit.

In accordance with embodiments, there is a computer program product comprising a non-transitory computer-readable storage medium having computer readable instructions stored thereon, the computer readable instructions being executable by a computerized device to cause the computerized device to perform a method of enabling ciphering error detection and recovery in a telecommunications network, the method comprising, at a network entity:

inserting predetermined data into at least one radio link control service data unit; and

transmitting the at least one radio link control service data unit comprising the predetermined data to a user equipment in the network,

whereby the user equipment is able to apply, on the basis of the predetermined data, either an unacknowledged mode radio link control ciphering error detection and recovery mechanism or a packet data convergence protocol ciphering error detection and recovery mechanism to the at least one radio link control service data unit.

In accordance with third embodiments, there is a method of enabling ciphering error detection and recovery in a telecommunications network, the method comprising, at a user equipment:

receiving at least one radio link control service data unit comprising predetermined data; and

applying, on the basis of the predetermined data, either an unacknowledged mode radio link control ciphering error detection and recovery mechanism or a packet data convergence protocol ciphering error detection and recovery mechanism to the at least one received radio link control service data unit.

In accordance with fourth embodiments, there is apparatus for use in enabling ciphering error detection and recovery in a telecommunications network, the apparatus comprising a processing system adapted to, at a user equipment:

receive at least one radio link control service data unit comprising predetermined data; and

apply, on the basis of the predetermined data, either an unacknowledged mode radio link control ciphering error detection and recovery mechanism or a packet data convergence protocol ciphering error detection and recovery mechanism to the at least one received radio link control service data unit.

In accordance with embodiments, there is a computer program product comprising a non-transitory computer-readable storage medium having computer readable instructions stored thereon, the computer readable instructions being executable by a computerized device to cause the computerized device to perform a method of enabling ciphering error detection and recovery in a telecommunications network, the method comprising, at a user equipment:

receiving at least one radio link control service data unit comprising predetermined data; and

applying, on the basis of the predetermined data, either an unacknowledged mode radio link control ciphering error detection and recovery mechanism or a packet data convergence protocol ciphering error detection and recovery mechanism to the at least one received radio link control service data unit.

Further features and advantages of the invention will become apparent from the following description of preferred embodiments of the invention, given by way of example only, which is made with reference to the accompanying drawings.

### BRIEF DESCRIPTION OF THE DRAWINGS

FIG. 1 shows a system diagram according to embodiments;

FIG. 2 shows a flow diagram according to embodiments;

FIG. 3 shows a schematic of an RLC PDU according to embodiments;

FIG. 4 shows a flow diagram according to embodiments;

FIG. 5 shows a system diagram according to embodiments;

FIG. 6 shows a flow chart according to embodiments;

FIG. 7 shows a flow chart according to embodiments;

FIG. 8 shows a flow chart according to embodiments;

FIG. 9 shows a flow chart according to embodiments;

FIG. 10 shows a flow chart according to embodiments; and

FIG. 11 shows a flow chart according to embodiments.

### DETAILED DESCRIPTION

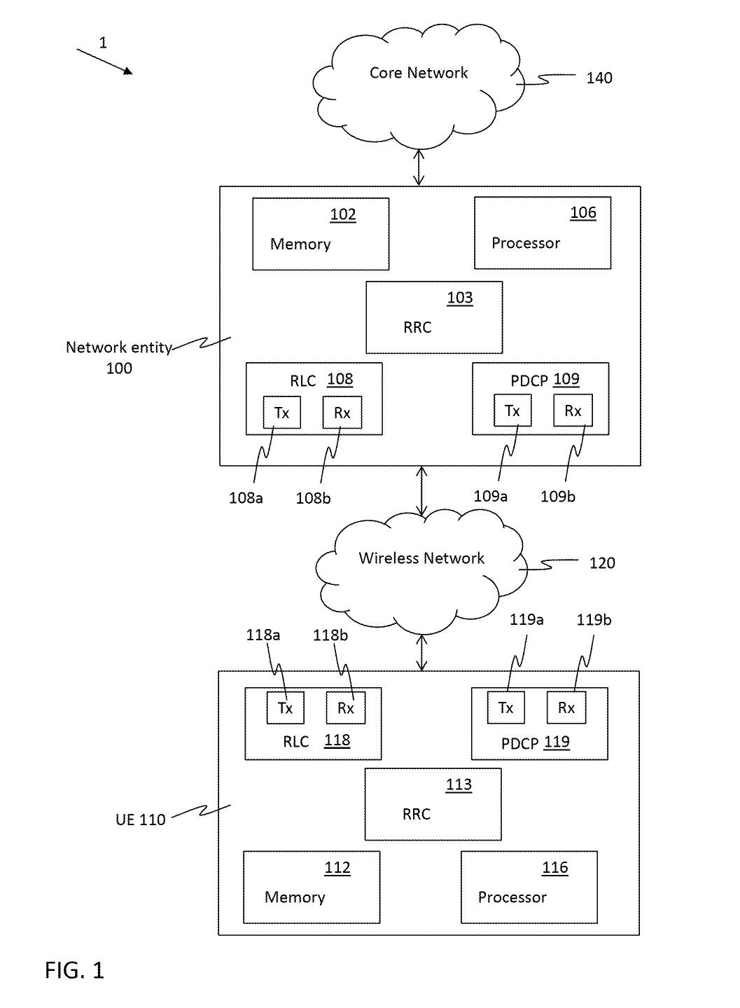

FIG. 1 shows a system diagram of a telecommunications network 1 for enabling ciphering error and detection according to embodiments. Telecommunications network 1 comprises a network entity 100 and a user equipment 110 connected by a wireless network 120.

Network entity (or network ‘node’) 100 comprises a memory 102, a processor 106, an RRC entity 103, an RLC entity 108 and a PDCP entity 109. Radio link control entity 108 comprises a transmitter part 108a and a receiver part 108b. PDCP entity 109 comprises a transmitter part 109a and a receiver part 109b. In embodiments, network entity 100 comprises a RNC.

In FIG. 1, network entity 100 comprises a single processor 106 which is depicted as a separate entity to RRC entity 103, RLC entity 108 and PDCP entity 109. Processor 106 may comprise a processing system of one or more processors. In other embodiments, network entity 100 comprises one or more further processors (not shown), for example a processor in RLC entity 108 and/or a processor PDCP entity 109. Various data processing actions of embodiments described below are described as being carried out by processor 106, but it should be understood that such actions could be carried out by one or more other processors, for example in RRC entity 103, RLC entity 108 and PDCP entity 109 or any combination thereof.

In FIG. 1, PDCP entity 109 is depicted as a separate entity to RLC entity 108. In other embodiments, PDCP entity 109 is located within RLC entity 108.

UE 110 comprises a memory 112, an RRC entity 113, a processor 116, an RLC entity 118 and a PDCP entity 119. RLC entity 118 comprises a transmitter part 118a and a receiver part 118b. PDCP entity 119 comprises a transmitter part 119a and a receiver part 119b.

In FIG. 1, UE 110 comprises a single processor 116 which is depicted as a separate entity to RRC entity 113, RLC entity 118 and PDCP entity 119. Processor 116 may comprise a processing system of one or more processors. In other embodiments, UE 100 comprises one or more further processors, for example a processor in RLC entity 118 and/or a processor PDCP entity 119. Various data processing actions of embodiments described below are described as being carried out by processor 116, but it should be understood that such actions could be carried out by one or more other processors, for example in RRC entity 113, RLC entity 118 and PDCP entity 119 or any combination thereof.

In FIG. 1, PDCP entity 119 is depicted as a separate entity to RLC entity 118. In other embodiments, PDCP entity 119 is located within RLC entity 118.

In embodiments, network 120 comprises one or more wireless or wireline networks, such as a cellular telephone network or public land mobile network (for example adapted to operate according to one or more 3GPP standards), and/or the Internet, etc.

Network entity 100 is adapted to communicate data to/from UE 110 via wireless network 120. In embodiments, wireless network 120 comprises one or more NodeBs (not shown)

In embodiments, network entity 100 and UE 110 comprise one or more communication interfaces (not shown) for facilitating such communication via wireless network 120. In embodiments, such communication interfaces comprise one or more antennas, transmitters, receivers. In embodiments, RLC entity 108 and/or PDCP entity 109 are comprised in a communication interface of network entity 100. In embodiments, RLC entity 118 and/or PDCP entity 119 are comprised in a communication interface of UE 110.

In embodiments, PDCP Tx entity 109a of network entity 100 receives downlink data (e.g. voice data) from core network 140 of telecommunications network 1. In embodiments, core network 140 comprises one or more SGCSN, GGSN, MMEs, P-GWs, S-GWs, and/or the Internet (not shown). PDCP Tx entity 109a packages PDCP PDUs into one or more RLC SDUs and passes these to RLC Tx entity 108a. RLC Tx entity 108a converts the RLC SDUs into RLC PDUs and the RLC PDUs are transmitted into wireless network 120. Note that if one RLC SDU cannot be fitted into one RLC PDU, then the RLC SDU is segmented into more than one RLC PDU for transmission into wireless network 120 (i.e. an RLC SDU is not always segmented). A reverse process, which will be clear to one skilled in the art, occurs for uplink data received at network entity 100 from wireless network 120.

Core network 140 can be referred to as an upper layer part of telecommunications network 1 and wireless network 140 can be referred to as a lower layer part of telecommunications network 1.

For CSoHSPA, current 3GPP specifications specify that a UE automatically configures PDCP ciphering error detection and recovery at the PDCP layer.

Embodiments introduce a new IE, which facilitates configuration of UM RLC ciphering error detection and recovery, even for a CSoHSPA service. Further, for a IMS voice service, the new IE indicates whether a UM RLC based ciphering error detection and recovery mode is configured or whether a PDCP based ciphering error detection and recovery mode is configured.

In order to provide the NW with the capability to configure UM RLC ciphering error detection and recovery instead of PDCP ciphering error detection and recovery for a circuit-switched service such as CSoHSPA service, and also provide the NW with the capability to configure UM RLC ciphering error detection for a packet-switched service such as IMS voice service, embodiments introduce a new IE in the form of a new radio bearer ciphering error detection and recovery configuration parameter which indicates which ciphering error detection mechanism should be used for the corresponding radio bearer (or radio access bearer).

Embodiments allow network operators which prefer to re-use PDCP ciphering error detection and recovery for IMS voice to do so. Embodiments also allow other network operators which prefer to employ UM RLC based ciphering error detection and recovery to do so.

Embodiments enable a more reliable ciphering error detection and recovery mechanism, such as UM RLC ciphering error detection and recovery mechanism, to be used for any service, for example according to the preference of a network vendor or network operator. Further, a legacy ciphering error detection and recovery mechanism, such as a PDCP ciphering error detection and recovery mechanism, can still be utilized even after a new ciphering detection scheme, such as a UM RLC ciphering error detection and recovery mechanism, is introduced in 3GPP.

In embodiments, if the new radio bearer ciphering error detection and recovery configuration parameter is present, then UM RLC ciphering error detection is configured for the corresponding RB's receiving RLC entity. If the new radio bearer ciphering error detection and recovery configuration parameter is absent, then UM RLC ciphering error detection and recovery is not configured for the corresponding RB's receiving RLC entity, which is associated with the PS domain (for example an IMS voice service), or PDCP ciphering error detection and recovery is configured for the corresponding RB's receiving RLC entity, which is associated with the CS domain (for example a CSoHSPA service).

In embodiments, if the new radio bearer ciphering error detection and recovery configuration parameter indicates a predetermined value (for example ‘1’), then UM RLC ciphering error detection and recovery is configured for the corresponding RB's receiving RLC entity. If the new radio bearer ciphering error detection and recovery configuration parameter indicates another predetermined value (for example ‘0’), then UM RLC ciphering error detection and recovery is not configured for the corresponding RB's receiving RLC entity, which is associated with the PS domain (for example an IMS voice service), or PDCP ciphering error detection and recovery is configured for the corresponding RB's receiving RLC entity, which is associated with the CS domain (for example a CSoHSPA service).

In embodiments, if the new radio bearer ciphering error detection and recovery configuration parameter indicates a predetermined value (for example ‘1’), then UM RLC ciphering error detection and recovery is configured for the corresponding RB's receiving RLC entity. If the new radio bearer ciphering error detection and recovery configuration parameter indicates another predetermined value (for example ‘0’), then PDCP ciphering error detection and recovery is configured for the corresponding RB's PDCP entity. In embodiments, a further predetermined value could be used for a further ciphering error detection and recovery mechanism (other than UM RLC ciphering error detection and recovery and PDCP ciphering error detection and recovery).

Embodiments which enable ciphering error detection and recovery in telecommunications network 1 are now described in relation to FIG. 1.

Processor 106 of network entity 100 determines whether to instruct RRC entity 103 to insert, into a radio resource control message, a first predetermined radio bearer ciphering error detection and recovery configuration parameter. In embodiments, the first predetermined radio bearer ciphering error detection and recovery configuration parameter is stored in memory 102 and retrieved from memory as and when required.

The inserted first predetermined radio bearer ciphering error detection and recovery configuration parameter is operable to instruct a UE, such as UE 110, in telecommunications network 1 to configure a first ciphering error detection and recovery mode.

Processor 106 then facilitates transmittal of the radio resource control message to UE 110, via network 120, for example by controlling and/or instructing RLC Tx 108a accordingly.

Processor 106 then facilitates transmittal of at least one radio link control service data unit to UE 110, via network 120, for example by controlling and/or instructing RLC Tx 108a accordingly.

As a result of transmittal of the radio resource control message and at least one radio link control service data unit to UE 110, in the case of the determination being positive, UE 110 is instructed to configure the first ciphering error detection and recovery mode and thus processes the at least one radio link control service data unit according to the first ciphering error detection and recovery mode.

As a result of transmittal of the radio resource control message and at least one radio link control service data unit to UE 110, in the case of the determination being negative, UE 110 processes the at least one radio link control service data unit according to a second, different ciphering error detection and recovery mode.

Upon receipt of the radio resource control message transmitted from network entity 100 at user equipment 110, processor 116 (possibly in conjunction with RRC entity 113) determines whether the received radio resource control message comprises the first predetermined radio bearer ciphering error detection and recovery configuration parameter.

In embodiments, the first predetermined radio bearer ciphering error detection and recovery configuration parameter is stored in memory 112 and retrieved from memory 112 as and when required by processor 116.

In response to processor 116 determining that the radio resource control message received from network entity 100 does comprise the first predetermined radio bearer ciphering error detection and recovery configuration parameter, processor 116 configures UE 110 into a first ciphering error detection and recovery mode, for example by instructing RLC entity 118 to configure itself into the first ciphering error detection and recovery mode.

Due to UE 110 being configured in the first ciphering error detection and recovery mode, when UE 110 receives the at least one radio link control service data unit transmitted from network entity 100, processor 116 processes (possibly in conjunction with RLC entity 118) the at least one received radio link control service data unit according to the configured first ciphering error detection and recovery mode.

In embodiments, the first ciphering error detection and recovery mode comprises an unacknowledged mode radio link control ciphering error detection and recovery mode. In embodiments, the processing of the at least one radio link control service data unit according to the unacknowledged mode radio link control ciphering error detection and recovery mode is carried out by an unacknowledged mode radio link control entity in UE 110, such as RLC entity 118 or an unacknowledged mode part thereof.

In embodiments, the first predetermined radio bearer ciphering error detection and recovery configuration parameter inserted by processor 106 of network entity 100 is operable to instruct a user equipment to configure receiver and transmitter parts of the user equipment into the first ciphering error detection and recovery mode.

In embodiments, the configuring of UE 110 comprises configuring receiver and transmitter parts of UE 110, such as RLC Tx 118a and RLC Rx 118b, into the first ciphering error detection and recovery mode.

In response to processor 116 determining that the radio resource control message received from network entity 100 does not comprise the first predetermined radio bearer ciphering error detection and recovery configuration parameter, processor 116 processes (possibly in conjunction with RLC entity 118 and/or PDCP entity 119) the at least one radio link control service data unit according to a second, different ciphering error detection and recovery mode.

In embodiments, the processor 116 is configured by default to process received radio link control service data units according to the second, different ciphering error detection and recovery mode. Therefore unless UE 110 receives a radio resource control message from network entity 100 which comprises the first predetermined radio bearer ciphering error detection and recovery configuration parameter, received radio link control service data units will be processed by UE 110 according to the second, different ciphering error detection and recovery mode.

In embodiments, the second, different ciphering error detection and recovery mode comprises a packet data convergence protocol ciphering error detection and recovery mode. In embodiments, the processing of the at least one radio link control service data unit according to the packet data convergence protocol ciphering error detection and recovery mode is carried out by a packet data convergence protocol entity in UE 110, such as PDCP entity 119.

In some embodiments, the determination is negative, i.e. processor 106 of network entity 100 determines not to insert a first predetermined radio bearer ciphering error detection and recovery configuration parameter into the radio resource control message. In embodiments, processor 106, prior to transmittal of the radio resource control message to UE 110, inserts into the radio resource control message, a second, different predetermined radio bearer ciphering error detection and recovery configuration parameter. The inserted second, different predetermined radio bearer ciphering error detection and recovery configuration parameter is operable to instruct a user equipment in the network, such as UE 110, to configure a second, different ciphering error detection and recovery mode.

Processor 106 then facilitates transmittal of the radio resource control message containing the second, different predetermined radio bearer ciphering error detection and recovery configuration parameter to UE 110, via network 120 and also transmittal of the at least one radio link control service data unit to UE 110, via network 120.

As a result of transmittal of the radio resource control message containing the second, different predetermined radio bearer ciphering error detection and recovery configuration parameter and the at least one radio link control service data unit to UE 110, UE 110 is instructed to configure the second, different ciphering error detection and recovery mode and thus processes the at the at least one radio link control service data unit according to the second, different ciphering error detection and recovery mode. Such embodiments may for example be employed to reconfigure UE 110 back into the second, different ciphering error detection and recovery mode after having previously been configured into the first ciphering error detection and recovery mode.

In embodiments, the first predetermined radio bearer ciphering error detection and recovery configuration parameter inserted by processor 106 of network entity 100 comprises a first predetermined value, and the inserted first predetermined radio bearer ciphering error detection and recovery configuration parameter having the first predetermined value is operable to instruct UE 100 to configure the first ciphering error detection and recovery mode in relation to the at least one received radio link control service data unit.

In embodiments, the first predetermined radio bearer ciphering error detection and recovery configuration parameter inserted by processor 106 of network entity 100 comprises a second predetermined value, and the inserted first predetermined radio bearer ciphering error detection and recovery configuration parameter having the second predetermined value is operable to instruct the user equipment to configure a second, different ciphering error detection and recovery mode in relation to the at least one radio link control service data unit.

In embodiments, one or more of the first and second predetermined values and the first and second, different predetermined radio bearer ciphering error detection and recovery configuration parameters are specified in a specification (for example in 3GPP specification 25.331). In other embodiments, one or more of the first and second predetermined values and the first and second, different predetermined radio bearer ciphering error detection and recovery configuration parameters are negotiated between network entity 100 and UE 110, for example via RRC signalling.

In embodiments, processor 116 of UE 110 identifies whether the first predetermined radio bearer ciphering error detection and recovery configuration parameter comprises a first predetermined value or a second predetermined value.

In some embodiments, the configuring of UE 110 into the first ciphering error detection and recovery mode is carried out in response to the identification identifying the first predetermined value.

In other embodiments, in response to the identification identifying the second predetermined value, UE 110 processes the at least one radio link control service data unit according to the second, different ciphering error detection and recovery mode.

The first predetermined value may for example comprise a value of ‘1’ and the second predetermined value may for example comprise a value of ‘0’.

In embodiments, the at least one radio link control service data unit is associated with an IP Multimedia Subsystem (IMS) voice service.

In embodiments, the at least one radio link control service data unit is associated with a circuit-switched voice communication over High Speed Packet Access (CSoHSPA) service.

In embodiments, the radio resource control message transmitted from network entity 100 to UE 110 comprises a radio resource control reconfiguration message. In embodiments, the radio resource control reconfiguration message comprises one of a RadioBearerSetup message and a RadioBearerReconfiguration message.

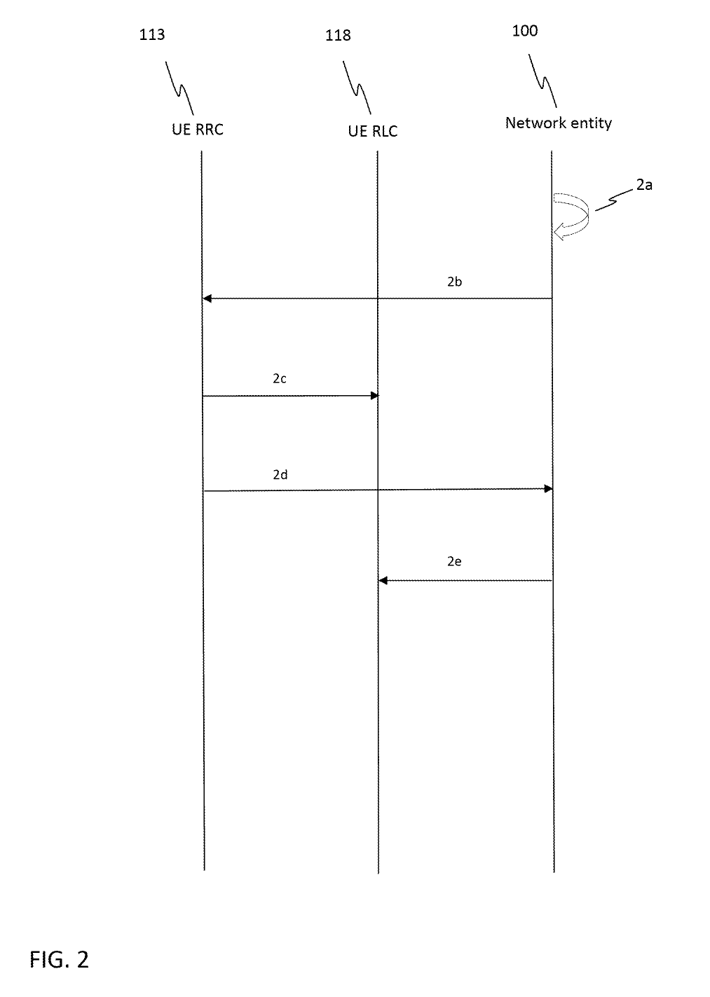

FIG. 2 shows a flow diagram according to embodiments. At item 2a, processor 106 of network entity 100, retrieves a first predetermined radio bearer ciphering error detection and recovery configuration parameter from memory 102 and inserts, into a radio resource control message, the first predetermined radio bearer ciphering error detection and recovery configuration parameter. The inserted first predetermined radio bearer ciphering error detection and recovery configuration parameter is operable to instruct a user equipment, such as UE 100, in telecommunications network 1 to configure a first ciphering error detection and recovery mode.

At item 2b, processor 106 of network entity 100 transmits the radio resource control message containing the first predetermined radio bearer ciphering error detection and recovery configuration parameter to UE 110 via network 120. The radio resource control message could for example comprise a RadioBearerSetup message or a RadioBearerReconfiguration message.

The radio resource control message of item 2b is received by UE 110 and passed to radio resource control entity 113 of UE 110. Radio resource control entity 113 of UE 110, determines (possibly in conjunction with processor 116) that the radio resource control message of item 2b contains the first predetermined radio bearer ciphering error detection and recovery configuration parameter, so instructs radio link control entity 118 of UE 110 to configure a first predetermined radio bearer ciphering error detection and recovery mode in item 2c. Radio link control entity 118 transmits a radio resource control message, for example a RadioBearerSetupComplete message or a RadioBearerReconfigurationComplete message, to network entity 100 in item 2d to confirm that the configuration has been carried out.

At item 2e, network entity 110 transmits one or more radio link control service data units to UE 110 via network 120. Upon receipt of the one or more radio link control service data units transmitted from network entity 100, UE 110 processes such radio link control service data units according to the configured first ciphering error detection and recovery mode.

Embodiments of the invention comprise introduction of an additional RLC PDU field, which can be used to verify that RLC PDU data has been correctly de-ciphered after the deciphering process.

For example, when UM RLC ciphering error detection is configured, a transmitter RLC entity adds a parity field (for example one-byte) just before the user data field then ciphers not only the RLC PDU user data field, but also the added parity field.

A receiving RLC entity then checks whether the parity field indicates an expected value after deciphering the RLC PDU. If the receiving RLC entity detects an invalid parity field N times consecutively, then the UM RLC entity reports an RLC unrecoverable error to an RRC entity in the receiving entity. The value N comprises a positive integer, for example 2. The RRC layer can then take necessary remedial action for the recovery of the RLC unrecoverable error. Such remedial action may for example involve initiating a cell update procedure or by reporting an RLC unrecoverable error by transmitting an uplink RRC message to a network entity such as a RNC network entity. The uplink RRC message may for example comprise a Signalling Connection Release Indication message.

In embodiments, the value N and/or the content of the added parity field comprise hardcoded values which are specified in one or more specifications, for example in 3GPP specification 25.322. In other embodiments, the value N and/or content of the parity field is negotiated between UE and NW, for example via RRC signalling. Such RRC signalling may comprise an RNC informing UE 110 of the expected value of the added parity field via a RRC reconfiguration message such as a RadioBearerSetup message and/or a RadioBearerReconfiguration message.

Embodiments which enable ciphering error detection and recovery in telecommunications network 1 are now described in relation to FIG. 1.

Processor 106 of network entity 100 inserts (possibly in conjunction with RLC 108 and/or PDCP entity 109) predetermined data into at least one radio link control service data unit. The predetermined data has the same form as a packet data convergence protocol header. The term ‘having the same form’ here should be interpreted as the predetermined data being identical to a packet data convergence protocol header, for example the predetermined data has the same number of bits and the same bit values as a packet data convergence protocol header would have.

Processor 106 then facilitates transmittal of the at least one radio link control service data unit containing the inserted predetermined data to UE 110, via network 120, for example by controlling and/or instructing RLC Tx 108a and/or PDCP 109a Tx accordingly.

Upon receipt of the at least one radio link control service data unit comprising the predetermined data by UE 110, UE 110 is able to apply either an unacknowledged mode radio link control ciphering error detection and recovery mechanism or a packet data convergence protocol ciphering error detection and recovery mechanism to the at least one received radio link control service data unit applying, on the basis of the predetermined data.

Depending on its configuration, UE 110 can choose to apply an unacknowledged mode radio link control ciphering error detection and recovery mechanism to the at least one radio link control service data unit, or UE 110 can choose to apply a packet data convergence protocol ciphering error detection and recovery mechanism.

As a result of such embodiments, the NW does not need to configure a PDCP entity to enable UM RLC ciphering error detection and recovery and so overhead associated with implementing PDCP functionality does not exist.

In embodiments, the predetermined data is inserted into a header part of the at least one radio link control service data unit.

In embodiments, the predetermined data is inserted into a new field of at least one radio link control protocol data unit generated from at least a first part of the at least one radio link control service data unit. An RLC SDU is conveyed by one or more RLC PDUs. If the RLC SDU size does not fit the RLC PDU data field, then the RLC SDU is segmented into more than one RLC PDUs.

In embodiments, the new field comprises a new parity field added to the at least one radio link control protocol data unit.

In embodiments, the new field is added into the at least one radio link control protocol data unit next to user data of the at least one radio link control protocol data unit.

In embodiments, the new field is added into the at least one radio link control protocol data unit next to a length indicator field of the at least one radio link control protocol data unit.

In embodiments, comprises a plurality of radio link control protocol data units are generated from the at least one radio link control service data unit and the predetermined data is inserted into a first radio link control protocol data unit in the plurality of radio link control protocol data units.

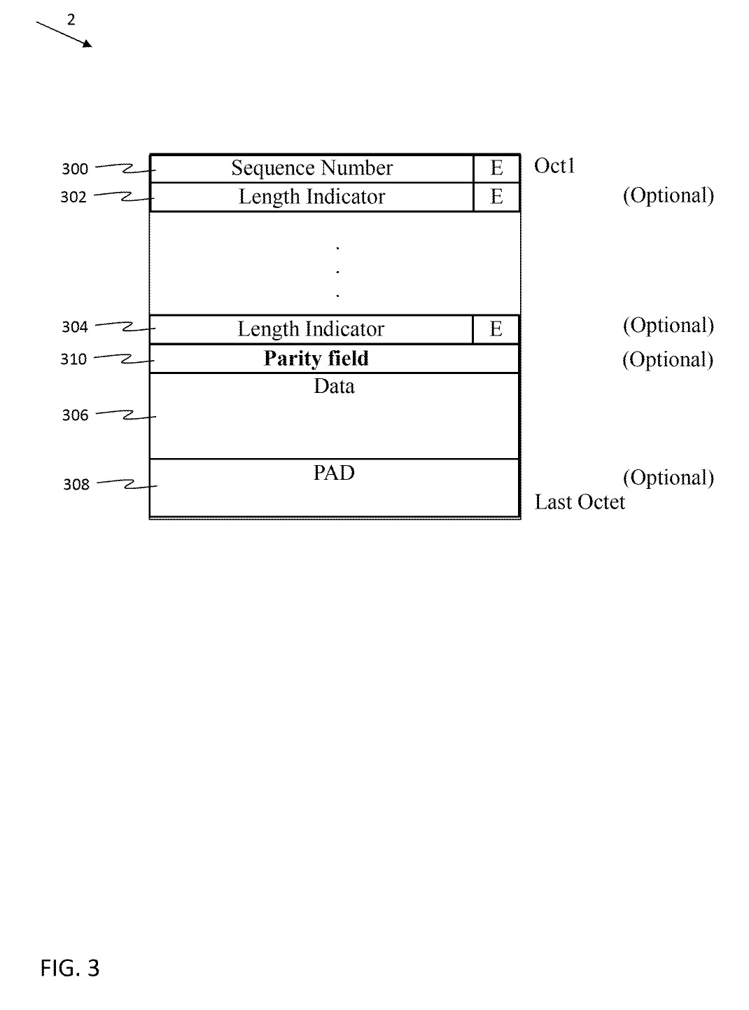

FIG. 3 shows a schematic of a radio link control protocol data unit 2 according to embodiments. Radio link control protocol data unit 2 comprises a sequence number field 300, a number of LI fields 302 to 304, a user data field 306 and a padding field (PAD) 308. In these embodiments, predetermined data is inserted into new parity field 310. The predetermined data inserted into the new parity field is intentionally selected such that is has the same form as a packet data convergence protocol header. The parity field can be seen to be located between user data field 306 and LI field 304.

In embodiments, radio link control protocol data unit 2 and zero or more other radio link control protocol data units are generated from a radio link control service data unit and the one or more radio link control protocol data units (including radio link control protocol data unit 2) are transmitted to UE 110. Upon receipt of radio link control service data unit 2 comprising the predetermined data by UE 110, UE 110 can apply either an unacknowledged mode radio link control ciphering error detection and recovery mechanism on the basis of the content of the parity field (i.e. the predetermined data) or a packet data convergence protocol ciphering error detection and recovery mechanism on the basis of the content of the packet data convergence protocol header (i.e. the predetermined data). In each case, the ciphering error detection and recovery mechanism is carried out on the basis of the predetermined data either at a RLC layer or a PDCP layer.

Note that the parity field can be present even when a LI field is not present in the RLC PDU, for example in the case that an alternative E-bit is configured.

Adding the parity field to the RLC PDU is intended to mimic the behaviour of a PDCP layer, i.e. encoding of the new RLC field is such that the field looks like a PDCP header. This means that even if a PDCP layer is not configured by the network, the UE has implementation freedom to perform the error detection function at either the RLC layer or the PDCP layer.

Because the new field is encoded in such a way that it looks identical to a PDCP header, the receiver entity can choose to implement ciphering error detection and recovery in either a RLC layer or a PDCP layer and the transmitter entity can similarly implement such in either a RLC layer or a PDCP layer.

In embodiments, network entity 100 configures a dummy packet data convergence protocol layer to carry out the insertion of the predetermined data having the same form as a packet data convergence protocol header into the at least one radio link control service data unit. The packet data convergence protocol layer configured by network entity 100 is a dummy layer because it does not carry out any other packet data convergence protocol processing, other than insertion of the predetermined data having the same form as a packet data convergence protocol header into the at least one radio link control service data unit.

In embodiments, the dummy packet data convergence protocol layer is configured in a radio link control entity 108 of network entity 100.

In embodiments, the at least one radio link control service data unit into which the predetermined data is inserted is associated with an IP Multimedia Subsystem (IMS) voice service.

In embodiments, the at least one radio link control service data unit into which the predetermined data is inserted is associated with a circuit-switched voice communication over High Speed Packet Access (CSoHSPA) service.

In embodiments, UE 110 configures a dummy packet data convergence protocol layer to carry out the application of the packet data convergence protocol ciphering error detection and recovery mechanism to the at least one received radio link control service data unit. In embodiments, the dummy packet data convergence protocol layer configured by UE 100 carries out the application of the packet data convergence protocol ciphering error detection and recovery mechanism by processing the packet data convergence protocol header contained in the at least one received radio link control service data unit. The packet data convergence protocol layer configured by UE 110 is a dummy layer because it does not carry out any other packet data convergence protocol processing, other than processing the packet data convergence protocol header contained in the at least one received radio link control service data unit.

In embodiments, the dummy packet data convergence protocol layer configured by UE 100 is configured in radio link control entity 118 of UE 100.

In embodiments, network entity 100 inserts predetermined data into a plurality of radio link control service data unit with the predetermined data having the same form as packet data convergence protocol headers. Network entity 100 then transmits the plurality of radio link control service data units containing the inserted predetermined data to UE 110, via network 120. Upon receipt of the plurality of radio link control service data units, UE 110 applies the unacknowledged mode radio link control ciphering error detection and recovery mechanism to the plurality of radio link control service data units.

In response to the applying of UE 110 resulting in detection of one or more errors in the predetermined data in a given number of consecutive received radio link control service data units in the plurality of radio link control service data units, UE 110 initiates a recovery procedure for a radio link control unrecoverable error.

In embodiments, the initiating comprises initiating a CellUpdate procedure.

In embodiments, the initiating comprises initiating radio link control or packet data convergence protocol error reporting in telecommunication network 1.

In embodiments, initiating the radio link control or packet data convergence protocol error reporting comprises UE 110 transmitting an uplink radio resource control message to network entity 100. In embodiments, the uplink radio resource control message transmitted from UE 110 to network entity 100 comprises a SignallingConnectionReleaseIndication message.

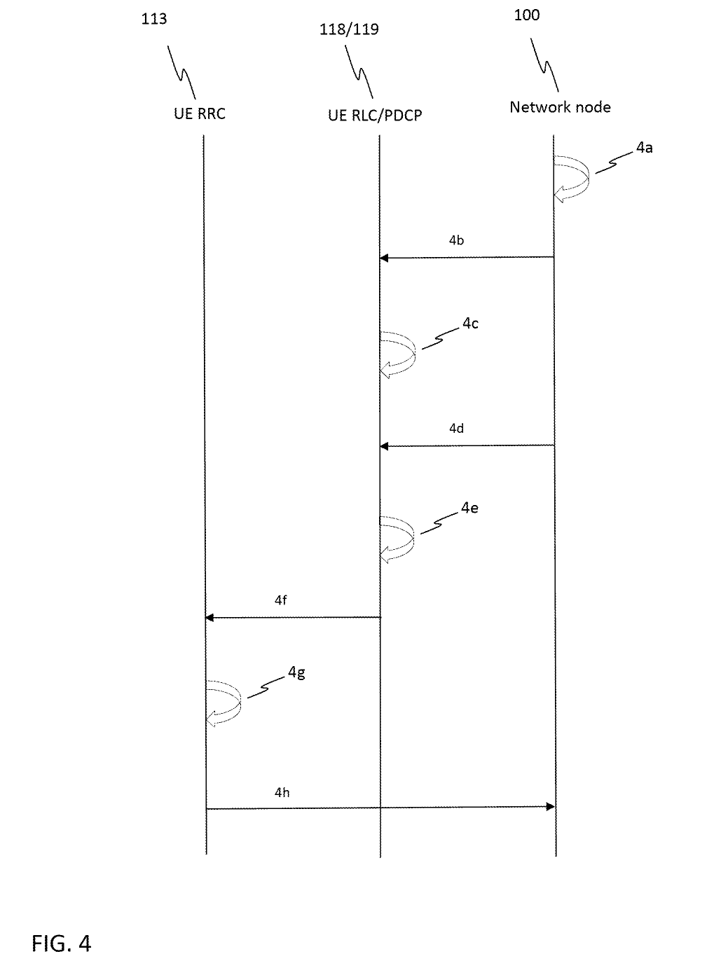

FIG. 4 shows a flow diagram according to embodiments. At item 4a, network node 100, receives downlink voice data (user data) from core network 140 of telecommunications network 1.

Processor 106 of network entity 100 creates (in conjunction with PDCP entity 109) a packet data convergence protocol protocol data unit from the user data and passes this in the form of a radio link control service data unit to RLC entity 108. Processor 106 (in conjunction with RLC entity 108) segments the radio link control service data unit into one or more radio link control protocol data units. If the radio link control service data unit is not small enough to fit into one radio link control protocol data unit, then the radio link control service data unit is segmented into more than one radio link control protocol data units.

In this embodiment, the radio link control service data unit is segmented into two radio link control protocol data units, i.e. a first radio link control protocol data unit and a second radio link control protocol data unit. Processor 106 of network entity 100 inserts (possibly in conjunction with RLC entity 108 and/or PDCP entity 109) predetermined data having the same form as a packet data convergence protocol header into the first radio link control protocol data unit generated from the radio link control service data unit.

At item 4b, network node 100 transmits (possibly in conjunction with RLC entity 108) the first radio link control protocol data unit generated from the radio link control service data unit to UE 110 via network 120.

The first radio link control protocol data unit is received by UE 110, and processor 116 (possibly in conjunction with RLC Rx entity 118b) checks whether the predetermined data contained within the first radio link control protocol data unit contains the correct expected value in item 4c. Which of RLC Rx entity 118b and PDCP Rx entity 119b performs the checks of the predetermined data will depend on configuration of UE 110.

At item 4d, network node 100 transmits the second radio link control protocol data unit generated from the radio link control service data unit to UE 110 via network 120.

Items 4a to 4d are then repeated a plurality of times for a plurality of radio link control service data units.

At item 4e, processor 116 (possibly in conjunction with RLC Rx entity 118b and/or PDCP Rx entity 119b) detects whether one or more errors in the predetermined data (i.e. discrepancies between the received predetermined data and an expected value for the received predetermined data) occur in a given number N of consecutive received radio link control service data units.

The given number N is a positive integer (for example 2) and comprises the number of consecutive radio link control service data units for which one or more errors may occur in the predetermined data before a recovery procedure for a radio link control unrecoverable error is initiated.

In embodiments, the given number N is a hardcoded value which is specified in a specification, for example in 3GPP specification 25.322. In other embodiments, the given number N is negotiated between UE 110 and network entity 100, for example via RRC signalling.

In response to processor 116 (possibly in conjunction with RLC Rx entity 118b and/or PDCP Rx entity 119b) detecting one or more errors in at least N consecutive received radio link control service data units, processor 116 indicates (possibly in conjunction with RLC Rx entity 118b and/or PDCP Rx entity 119b) an RLC unrecoverable status to RRC entity 113 of UE 110 in item 4f.

Upon receipt of the status indication of item 4f, RRC entity 113 of UE 110 initiates a recovery procedure for a radio link control unrecoverable error in item 4g, for example by initiating a CellUpdate procedure or radio link control or packet data convergence protocol error reporting in telecommunication network 1.

Initiating the radio link control or packet data convergence protocol error reporting may comprise RRC entity 113 of UE 110 transmitting an uplink radio resource control message to network entity 100 in item 4h, for example a SignallingConnectionReleaseIndication message.

In the embodiments of FIG. 4 described above, network node 100 may comprise an RNC.

In embodiments described above, predetermined data is inserted into at least one radio link control service data unit at a network node 100 and the at least one radio link control service data unit is transmitted from network node 100 to a UE 110, i.e. in a downlink direction. Such embodiments may equally apply in the opposite direction, i.e. in an uplink direction, where predetermined data is inserted into at least one radio link control service data unit by a UE 110 and the at least one radio link control service data unit and transmitted from UE 110 to network node 100.

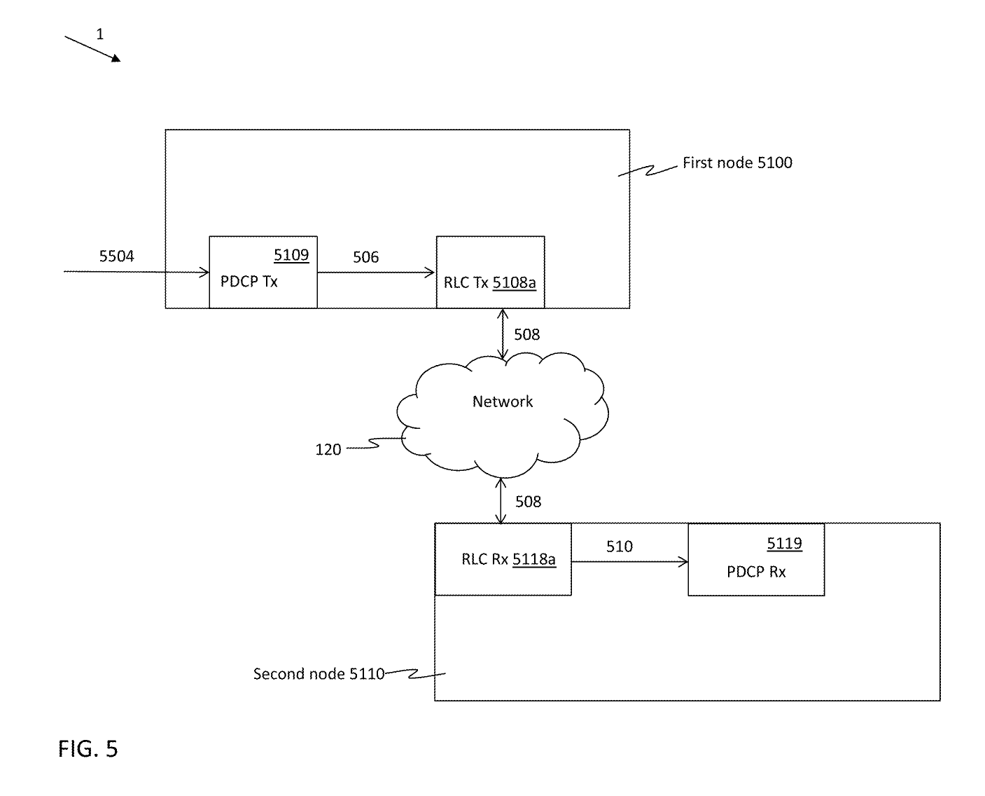

FIG. 5 shows a system diagram according to embodiments. Embodiments for enabling ciphering error detection and recovery in a telecommunications network 1 are now described in relation to FIG. 5.

At a first node 5100, user data 5504 is passed to a packet data convergence protocol entity (PDCP Tx 5109).

At packet data convergence protocol entity PDCP Tx 5109, a packet data convergence protocol protocol data unit is generated by adding a packet data convergence protocol header to the user data. The packet data convergence protocol protocol data unit is passed 506 to a radio link control transmitter entity RLC Tx 5108a.

At the radio link control transmitter entity RLC Tx 5108a, the packet data convergence protocol protocol data unit is received as a radio link control service data unit. The packet data convergence protocol header is contained in a parity field of a radio link control protocol data unit generated from a first part of the radio link control service data unit. The radio link control service data unit comprising the packet data convergence protocol header is transmitted 508 to a second node 5110 in telecommunication network 1 (in this case via network 120).

As a result of receipt of the radio link control service data unit, the second node 5110 is able to apply, either an unacknowledged mode radio link control ciphering error detection and recovery mechanism on the basis of the parity field or a packet data convergence protocol ciphering error detection and recovery mechanism on the basis of the packet data convergence protocol header to the radio link control service data unit.

In embodiments, packet data convergence protocol entity PDCP Tx 5109 of first node 5100 does not carry out any packet data convergence protocol related processing other than the generating and passing.

In embodiments, the first node 5100 comprises a network entity, such as network entity 100, the second node 5110 comprises a user equipment, such as UE 110, and the radio link control service data unit is transmitted in a downlink direction.

In embodiments, the first node 5100 comprises a user equipment, such as UE 110, the second node 5110 comprises a network entity, such as network entity 100, and the radio link control service data unit is transmitted in an uplink direction.

Further embodiments for enabling ciphering error detection and recovery in a telecommunications network 1 are now described in relation to FIG. 5.

A radio link control service data unit comprising a packet data convergence protocol header is received 508 at a radio link control receiver entity RLC Rx 5118a in a second node 5110. The packet data convergence protocol header is contained in a parity field of a radio link control protocol data unit generated from a first part of the radio link control service data unit.

In some embodiments, radio link control receiver entity 5118a in node 5110 applies, to the received radio link control service data unit, an unacknowledged mode radio link control ciphering error detection and recovery mechanism on the basis of the parity field.

In other embodiments, radio link control receiver entity 5118a in node 5110 passes 510 the received radio link control service data unit to a packet data convergence protocol entity PDCP Rx 5119 of node 5110.

In embodiments where the received radio link control service data unit is passed to packet data convergence protocol entity PDCP Rx 5119, packet data convergence protocol entity PDCP Rx 5119 applies, to the radio link control service data unit, a packet data convergence protocol ciphering error detection and recovery mechanism on the basis of the packet data convergence protocol header.

In embodiments, packet data convergence protocol entity PDCP Rx 5119 of node 5110 does not carry out any packet data convergence protocol related processing other than the application of the packet data convergence protocol ciphering error detection and recovery mechanism.

In embodiments, node 5110 comprises a network entity, such as network entity 100, and the radio link control service data unit is received in an uplink direction.

In embodiments, node 5110 comprises a user equipment, such as UE 110, and the radio link control service data unit is received in a downlink direction.

In the embodiments described above in relation to FIG. 5, PDCP Tx entity 5109 is depicted as being a separate entity to RLC Tx entity 5108a. In other embodiments, PDCP Tx entity 5109 is located within an RLC entity of node 5100, for example within RLC Tx 5108a.

In the embodiments described above in relation to FIG. 5, PDCP Rx entity 5119 is depicted as being a separate entity to RLC entity 5118a. In other embodiments, PDCP Rx entity 5119 is located within an RLC entity of node 5110, for example within RLC Rx 5118a.

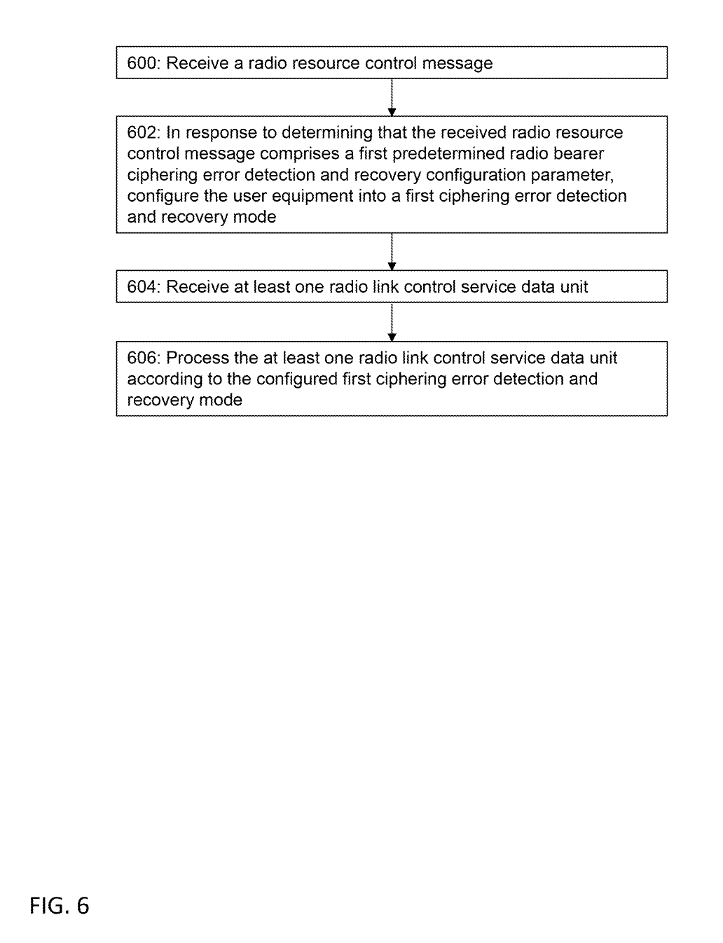

FIG. 6 shows a flow chart according to embodiments. Embodiments for enabling ciphering error detection and recovery in a telecommunications network are now described in relation to FIG. 6, such embodiments being carried out at a user equipment.

At item 600, a radio resource control message is received.

At item 602, in response to determining that the received radio resource control message comprises a first predetermined radio bearer ciphering error detection and recovery configuration parameter, the user equipment is configured into a first ciphering error detection and recovery mode.

At item 604, at least one radio link control service data unit is received.

At item 606, the at least one radio link control service data unit is processed according to the configured first ciphering error detection and recovery mode.

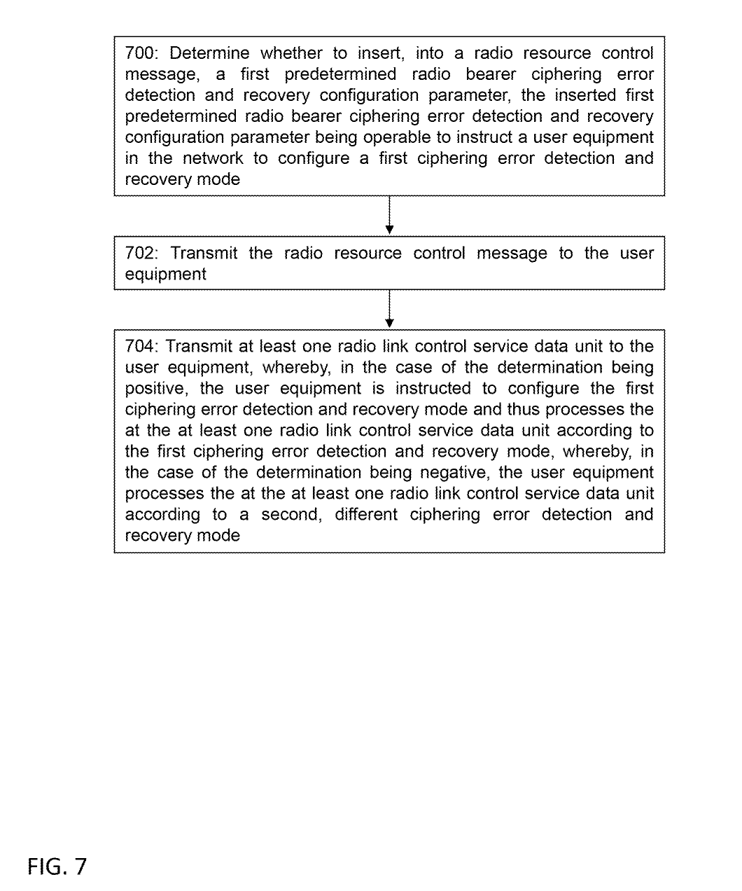

FIG. 7 shows a flow chart according to embodiments. Embodiments for enabling ciphering error detection and recovery in a telecommunications network are now described in relation to FIG. 7, such embodiments being carried out at a network entity.

At item 700, it is determined whether to insert, into a radio resource control message, a first predetermined radio bearer ciphering error detection and recovery configuration parameter, the inserted first predetermined radio bearer ciphering error detection and recovery configuration parameter being operable to instruct a user equipment in the network to configure a first ciphering error detection and recovery mode;

At item 702, the radio resource control message is transmitted to the user equipment.

At item 704, the at least one radio link control service data unit is transmitted to the user equipment.

As a result, in the case of the determination being positive, the user equipment is instructed to configure the first ciphering error detection and recovery mode and thus processes the at the at least one radio link control service data unit according to the first ciphering error detection and recovery mode,

As a result, in the case of the determination being negative, the user equipment processes the at the at least one radio link control service data unit according to a second, different ciphering error detection and recovery mode.

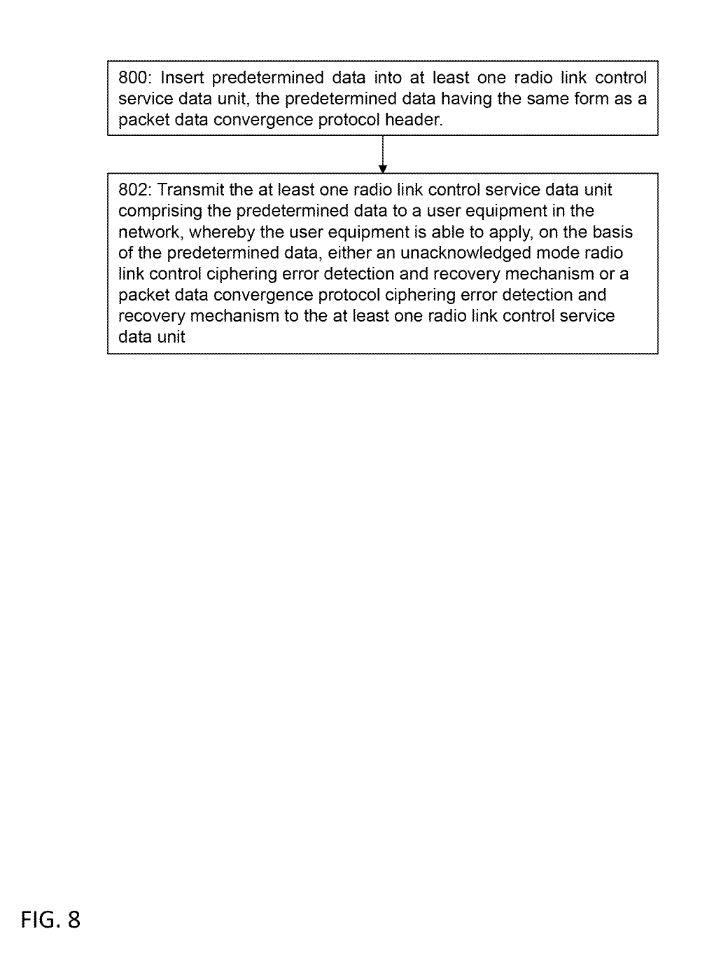

FIG. 8 shows a flow chart according to embodiments. Embodiments for enabling ciphering error detection and recovery in a telecommunications network are now described in relation to FIG. 8, such embodiments being carried out at a network entity.

At item 800, predetermined data is inserted into at least one radio link control service data unit, the predetermined data having the same form as a packet data convergence protocol header.

At item 802, the at least one radio link control service data unit comprising the predetermined data is transmitted to a user equipment in the network.

As a result, the user equipment is able to apply, on the basis of the predetermined data, either an unacknowledged mode radio link control ciphering error detection and recovery mechanism or a packet data convergence protocol ciphering error detection and recovery mechanism to the at least one radio link control service data unit.

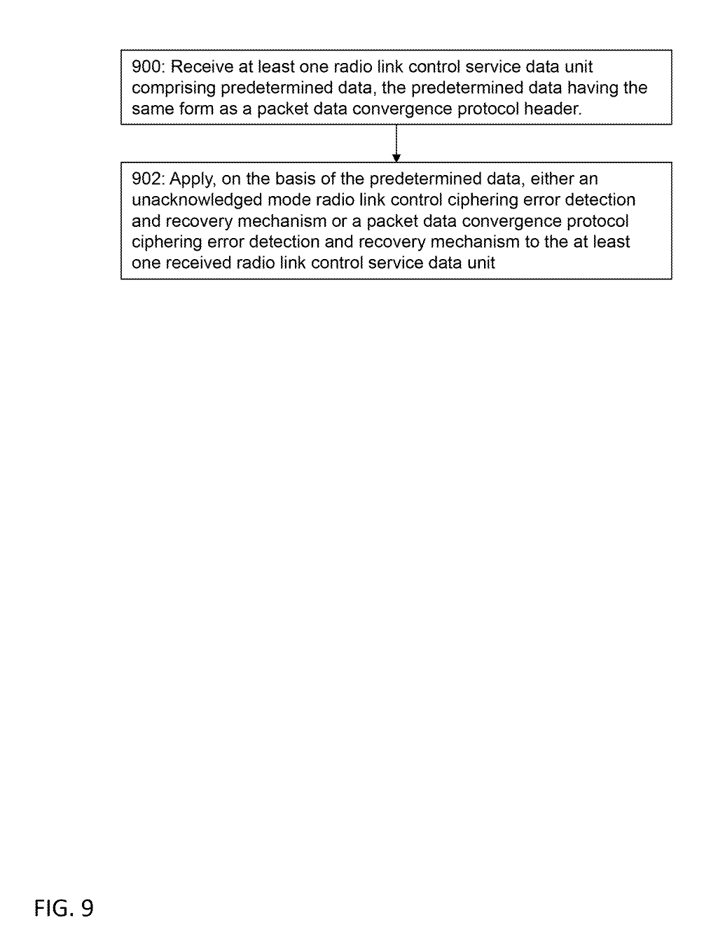

FIG. 9 shows a flow chart according to embodiments. Embodiments for enabling ciphering error detection and recovery in a telecommunications network are now described in relation to FIG. 9, such embodiments being carried out at a user equipment.

At item 900, at least one radio link control service data unit comprising predetermined data is received, the predetermined data having the same form as a packet data convergence protocol header.

At item 902, either an unacknowledged mode radio link control ciphering error detection and recovery mechanism or a packet data convergence protocol ciphering error detection and recovery mechanism is applied to the at least one received radio link control service data unit on the basis of the predetermined data.

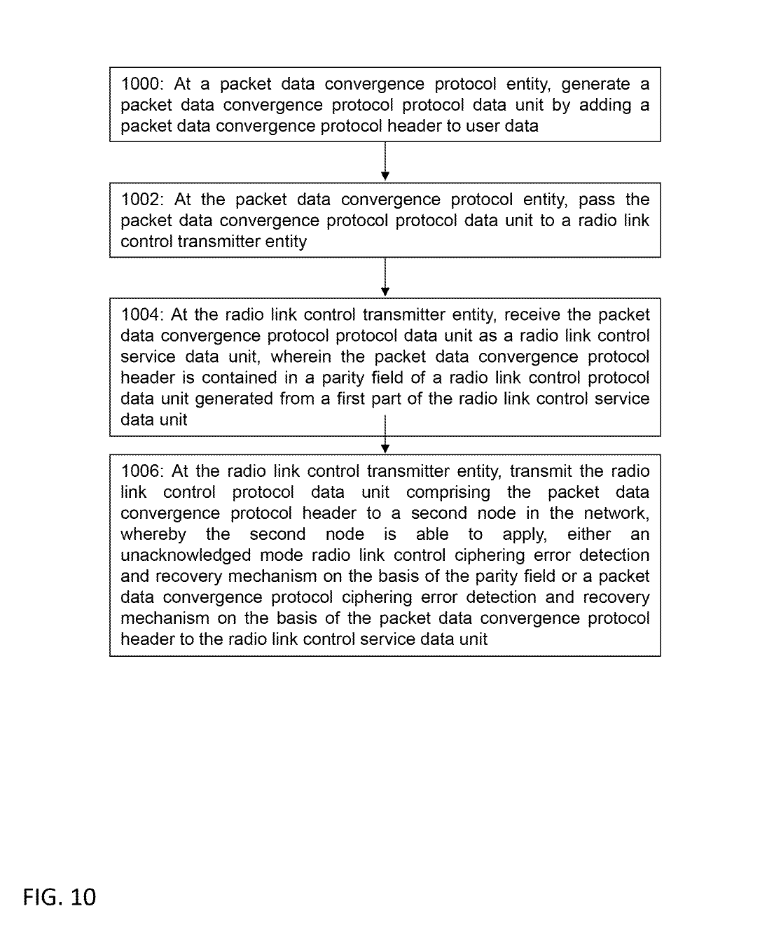

FIG. 10 shows a flow chart according to embodiments. Embodiments for enabling ciphering error detection and recovery in a telecommunications network are now described in relation to FIG. 10, such embodiments being carried out at a first node in the network.

At item 1000, a packet data convergence protocol protocol data unit is generated at a packet data convergence protocol entity by adding a packet data convergence protocol header to user data.

At item 1002, at the packet data convergence protocol entity, the packet data convergence protocol protocol data unit is passed to a radio link control transmitter entity.

At item 1004, at the radio link control transmitter entity, the packet data convergence protocol protocol data unit is received as a radio link control service data unit, wherein the packet data convergence protocol header is contained in a parity field of a radio link control protocol data unit generated from a first part of the radio link control service data unit.

At item 1006, at the radio link control transmitter entity, the radio link control protocol data unit comprising the packet data convergence protocol header is transmitted to a second node in the network.

As a result, the second node is able to apply, either an unacknowledged mode radio link control ciphering error detection and recovery mechanism on the basis of the parity field or a packet data convergence protocol ciphering error detection and recovery mechanism on the basis of the packet data convergence protocol header to the radio link control service data unit.

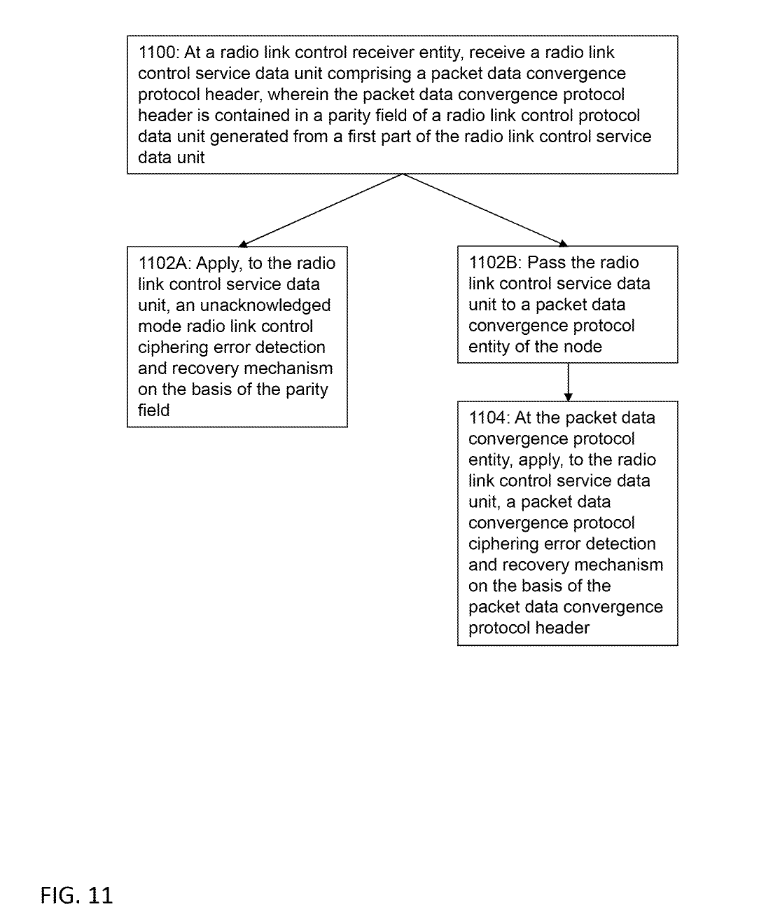

FIG. 11 shows a flow chart according to embodiments. Embodiments for enabling ciphering error detection and recovery in a telecommunications network are now described in relation to FIG. 11, such embodiments being carried out at a node in the network.

At item 1100, a radio link control service data unit comprising a packet data convergence protocol header is received at a radio link control receiver entity, wherein the packet data convergence protocol header is contained in a parity field of a radio link control protocol data unit generated from a first part of the radio link control service data unit.

Either:

At item 1102A, at the radio link control receiver entity, an unacknowledged mode radio link control ciphering error detection and recovery mechanism is applied to the radio link control service data unit on the basis of the parity field.

Or:

At item 1102B, at the radio link control receiver entity, the radio link control service data unit is passed to a packet data convergence protocol entity of the node.

At item 1104, at the packet data convergence protocol entity, in the case of the radio link control service data unit being passed to the packet data convergence entity, a packet data convergence protocol ciphering error detection and recovery mechanism is applied to the radio link control service data unit on the basis of the packet data convergence protocol header.

Note that 3GPP specifications use the term “UM RLC ciphering error detection and recovery” to refer to PDCP ciphering error detection and recovery.

To avoid any confusion in relation to such 3GPP terminology herein, the unacknowledged mode radio link control ciphering error detection and recovery mode (or mechanism) referred to in embodiments herein, could be referred to as an unacknowledged mode radio link control ciphering error detection and recovery mode (or mechanism) performed in a UM RLC entity. Similarly, to avoid any confusion in relation to such 3GPP terminology herein, the packet data convergence protocol ciphering error detection and recovery mode (or mechanism) referred to in embodiments herein, could be referred to as a packet data convergence protocol ciphering error detection and recovery mode (or mechanism) performed in a PDCP entity.

Various embodiments of network entity 100 and user equipment 110 can include, but are not limited to: user equipment, endpoint device, mobile (or ‘cellular’) telephones (including so-called “smart phones”), data cards, USB dongles, personal portable digital devices having wireless communication capabilities including but not limited to laptop/palmtop/tablet computers, digital cameras and music devices, sensor network components, Internet appliances, a network entity such as an RNC, an MME, a base station, a node B, an evolved node B (eNB), etc.

Various embodiments of memories 102 and 112 include any data storage technology type which is suitable to the local technical environment, including but not limited to semiconductor based memory devices, magnetic memory devices and systems, optical memory devices and systems, fixed memory, removable memory, disc memory, flash memory, DRAM, SRAM, EEPROM and the like. Various embodiments of processors 106 and 116 include but are not limited to microprocessors, digital signal processors (DSPs), multi-core processors, general purpose computers, and special purpose computers.

It will be understood that any of processors 106 and 116 or processing system or circuitry referred to herein may in practice be provided by a single chip or integrated circuit or plural chips or integrated circuits, optionally provided as a chipset, an application-specific integrated circuit (ASIC), field-programmable gate array (FPGA), etc. The chip or chips may comprise circuitry (as well as possibly firmware) for embodying at least one or more of a data processor or processors, a digital signal processor or processors, baseband circuitry and radio frequency circuitry, which are configurable so as to operate in accordance with the exemplary embodiments. In this regard, the exemplary embodiments may be implemented at least in part by computer software stored in (non-transitory) memory and executable by the processor, or by hardware, or by a combination of tangibly stored software and hardware (and tangibly stored firmware).

Although at least some aspects of the embodiments described herein with reference to the drawings comprise computer processes performed in processing systems or processors, the invention also extends to computer software, computer programs, particularly computer programs on or in a carrier, adapted for putting the invention into practice. The program may be in the form of non-transitory source code, object code, a code intermediate source and object code such as in partially compiled form, or in any other non-transitory form suitable for use in the implementation of processes according to the invention. The carrier may be any entity or device capable of carrying the program. For example, the carrier may comprise a storage medium, such as a solid-state drive (SSD) or other semiconductor-based RAM; a ROM, for example a CD ROM or a semiconductor ROM; a magnetic recording medium, for example a floppy disk or hard disk; optical memory devices in general; etc.

While network 120 may be configured in accordance with LTE or LTE-Advanced (LTE-A), other networks may support the method, apparatus and computer program product of embodiments including those configured in accordance with W-CDMA, CDMA2000, GSM, GPRS and/or the like.

Embodiments comprise apparatus for use in enabling ciphering error detection and recovery in a telecommunications network, the apparatus comprising, at a network entity:

means for inserting predetermined data into at least one radio link control service data unit; and

means for transmitting the at least one radio link control service data unit comprising the predetermined data to a user equipment in the network,

whereby the user equipment is able to apply, on the basis of the predetermined data, either an unacknowledged mode radio link control ciphering error detection and recovery mechanism or a packet data convergence protocol ciphering error detection and recovery mechanism to the at least one radio link control service data unit.

Embodiments comprise apparatus for use in enabling ciphering error detection and recovery in a telecommunications network, the apparatus comprising, at a user equipment:

means for receiving at least one radio link control service data unit comprising predetermined data; and

means for applying, on the basis of the predetermined data, either an unacknowledged mode radio link control ciphering error detection and recovery mechanism or a packet data convergence protocol ciphering error detection and recovery mechanism to the at least one received radio link control service data unit.

Embodiments comprise apparatus for use in enabling ciphering error detection and recovery in a telecommunications network, the apparatus comprising, at a first node in the network:

at a packet data convergence protocol entity:
means for generating a packet data convergence protocol protocol data unit by adding a packet data convergence protocol header to user data; and
means for passing the packet data convergence protocol protocol data unit to a radio link control transmitter entity; and

at the radio link control transmitter entity:
means for receiving the packet data convergence protocol protocol data unit as a radio link control service data unit, wherein the packet data convergence protocol header is contained in a parity field of a radio link control protocol data unit generated from a first part of the radio link control service data unit; and
means for transmitting the radio link control protocol data unit comprising the packet data convergence protocol header to a second node in the network,

whereby the second node is able to apply, either an unacknowledged mode radio link control ciphering error detection and recovery mechanism on the basis of the parity field or a packet data convergence protocol ciphering error detection and recovery mechanism on the basis of the packet data convergence protocol header to the radio link control protocol data unit.

Embodiments comprise apparatus for use in enabling ciphering error detection and recovery in a telecommunications network, the apparatus comprising, at a node in the network:

at a radio link control receiver entity:
means for receiving a radio link control service data unit comprising a packet data convergence protocol header, wherein the packet data convergence protocol header is contained in a parity field of a radio link control protocol data unit generated from the radio link control service data unit; and

either:
means for applying, to the radio link control service data unit, an unacknowledged mode radio link control ciphering error detection and recovery mechanism on the basis of the parity field; or
means for passing the radio link control service data unit to a packet data convergence protocol entity of the node; and

at the packet data convergence protocol entity:
means for in the case of the radio link control service data unit being passed to the packet data convergence entity, applying, to the radio link control service data unit, a packet data convergence protocol ciphering error detection and recovery mechanism on the basis of the packet data convergence protocol header. The following numbered clauses set forth various embodiments:

1. A method of enabling ciphering error detection and recovery in a telecommunications network, the method comprising at a first node in said network:

at a packet data convergence protocol entity:
generating a packet data convergence protocol protocol data unit by adding a packet data convergence protocol header to user data; and
passing said packet data convergence protocol protocol data unit to a radio link control transmitter entity; and

at said radio link control transmitter entity:
receiving said packet data convergence protocol protocol data unit as a radio link control service data unit, wherein said packet data convergence protocol header is contained in a parity field of a radio link control protocol data unit generated from a first part of said radio link control service data unit; and
transmitting said radio link control protocol data unit comprising said packet data convergence protocol header to a second node in said network,

whereby said second node is able to apply, either an unacknowledged mode radio link control ciphering error detection and recovery mechanism on the basis of said parity field or a packet data convergence protocol ciphering error detection and recovery mechanism on the basis of said packet data convergence protocol header to said radio link control protocol data unit.

2. A method according to clause 1, wherein said packet data convergence protocol entity of said first node does not carry out any packet data convergence protocol related processing other than said generating and passing.

3. A method according to clause 1 or 2, wherein said first node comprises a network entity, said second node comprises a user equipment and said radio link control service data unit is transmitted in a downlink direction.

4. A method according to clause 1 or 2, wherein said first node comprises a user equipment, said second node comprises a network entity and said radio link control service data unit is transmitted in an uplink direction.

5. Apparatus for use in enabling ciphering error detection and recovery in a telecommunications network, the apparatus comprising a processing system adapted to, at a first node in said network:

at a packet data convergence protocol entity:
generate a packet data convergence protocol protocol data unit by adding a packet data convergence protocol header to user data; and
pass said packet data convergence protocol protocol data unit to a radio link control transmitter entity; and

at said radio link control transmitter entity:
receive said packet data convergence protocol protocol data unit as a radio link control service data unit, wherein said packet data convergence protocol header is contained in a parity field of a radio link control protocol data unit generated from a first part of said radio link control service data unit; and
transmit said radio link control protocol data unit comprising said packet data convergence protocol header to a second node in said network,

whereby said second node is able to apply, either an unacknowledged mode radio link control ciphering error detection and recovery mechanism on the basis of said parity field or a packet data convergence protocol ciphering error detection and recovery mechanism on the basis of said packet data convergence protocol header to said radio link control protocol data unit.

6. A computer program product comprising a non-transitory computer-readable storage medium having computer readable instructions stored thereon, the computer readable instructions being executable by a computerized device to cause the computerized device to perform a method of enabling ciphering error detection and recovery in a telecommunications network, the method comprising, at a first node in said network:

at a packet data convergence protocol entity:
generating a packet data convergence protocol protocol data unit by adding a packet data convergence protocol header to user data; and
passing said packet data convergence protocol protocol data unit to a radio link control transmitter entity; and

at said radio link control transmitter entity:
receiving said packet data convergence protocol protocol data unit as a radio link control service data unit, wherein said packet data convergence protocol header is contained in a parity field of a radio link control protocol data unit generated from a first part of said radio link control service data unit; and
transmitting said radio link control protocol data unit comprising said packet data convergence protocol header to a second node in said network,

whereby said second node is able to apply, either an unacknowledged mode radio link control ciphering error detection and recovery mechanism on the basis of said parity field or a packet data convergence protocol ciphering error detection and recovery mechanism on the basis of said packet data convergence protocol header to said radio link control protocol data unit.

7. A method of enabling ciphering error detection and recovery in a telecommunications network, the method comprising at a node in said network:

at a radio link control receiver entity:
receiving a radio link control service data unit comprising a packet data convergence protocol header, wherein said packet data convergence protocol header is contained in a parity field of a radio link control protocol data unit generated from said radio link control service data unit; and

either:
applying, to said radio link control service data unit, an unacknowledged mode radio link control ciphering error detection and recovery mechanism on the basis of said parity field; or
passing said radio link control service data unit to a packet data convergence protocol entity of said node; and

at said packet data convergence protocol entity:
in the case of said radio link control service data unit being passed to said packet data convergence entity, applying, to said radio link control service data unit, a packet data convergence protocol ciphering error detection and recovery mechanism on the basis of said packet data convergence protocol header.

8. A method according to clause 7, wherein said packet data convergence protocol entity of said node does not carry out any packet data convergence protocol related processing other than said application of said packet data convergence protocol ciphering error detection and recovery mechanism.

9. A method according to clause 6 or 7, wherein said node comprises a network entity and said radio link control service data unit is received in an uplink direction.

10. A method according to clause 6 or 7, wherein said node comprises a user equipment and said radio link control service data unit is received in a downlink direction.

11. Apparatus for use in enabling ciphering error detection and recovery in a telecommunications network, the apparatus comprising a processing system adapted to, at a node in said network:

at a radio link control receiver entity:
receive a radio link control service data unit comprising a packet data convergence protocol header, wherein said packet data convergence protocol header is contained in a parity field of a radio link control protocol data unit generated from said radio link control service data unit; and

either:
apply, to said radio link control service data unit, an unacknowledged mode radio link control ciphering error detection and recovery mechanism on the basis of said parity field; or
pass said radio link control service data unit to a packet data convergence protocol entity of said node; and

at said packet data convergence protocol entity:
in the case of said radio link control service data unit being passed to said packet data convergence entity, apply, to said radio link control service data unit, a packet data convergence protocol ciphering error detection and recovery mechanism on the basis of said packet data convergence protocol header.

12. A computer program product comprising a non-transitory computer-readable storage medium having computer readable instructions stored thereon, the computer readable instructions being executable by a computerized device to cause the computerized device to perform a method of enabling ciphering error detection and recovery in a telecommunications network, the method comprising, at a node in said network:

at a radio link control receiver entity:
receiving a radio link control service data unit comprising a packet data convergence protocol header, wherein said packet data convergence protocol header is contained in a parity field of a radio link control protocol data unit generated from said radio link control service data unit; and

either:
applying, to said radio link control service data unit, an unacknowledged mode radio link control ciphering error detection and recovery mechanism on the basis of said parity field; or
passing said radio link control service data unit to a packet data convergence protocol entity of said node; and

at said packet data convergence protocol entity:
in the case of said radio link control service data unit being passed to said packet data convergence entity, applying, to said radio link control service data unit, a packet data convergence protocol ciphering error detection and recovery mechanism on the basis of said packet data convergence protocol header.

The above embodiments are to be understood as illustrative examples of the invention. Further embodiments of the invention are envisaged. The term ‘embodiments’ used herein should be interpreted as meaning ‘some examples’ or ‘some embodiments’. It is to be understood that any feature described in relation to any one embodiment may be used alone, or in combination with other features described, and may also be used in combination with one or more features of any other of the embodiments, or any combination of any other of the embodiments. For example, any embodiment which involves use of a predetermined radio bearer ciphering error detection and recovery configuration parameter may be combined with any embodiment which involves insertion of predetermined data such as predetermined data having the same form as a packet data convergence protocol header. Furthermore, equivalents and modifications not described above may also be employed without departing from the scope of the invention, which is defined in the accompanying claims.

### LIST OF ACRONYMS AND ABBREVIATIONS

### 3GPP 3rd Generation Partnership Project

CS circuit switched
CSoHSPA CS voice over HSPA
HFN hyper frame number

### GGSN Gateway GPRS Support Node

GSM global system for mobile communications
GPRS general packet radio service
HSPA high speed packet access
IE information element
IMS IP multimedia subsystem
LI length indicator
LTE long term evolution

### LTE-A LTE-advanced

MME mobility management entity
NW network
PDCP packet data convergence protocol
PDU protocol data unit
P-GW packet data network gateway
PS packet switched
RAB radio access bearer
RB radio bearer
RLC radio link control
RNC radio network controller
RRC radio resource control
Rx receiver

### SGSN Serving GPRS Support Node

S-GW serving gateway
Tx transmitter
UE user equipment
UM unacknowledged mode
UMTS universal mobile telecommunications system
W-CDMA wideband code division multiple access

1. A method of enabling ciphering error detection and recovery in a telecommunications network, the method comprising, at a network entity:
inserting predetermined data into at least one radio link control service data unit; and
transmitting the at least one radio link control service data unit comprising the predetermined data to a user equipment in the network,
whereby the user equipment is able to apply, on the basis of the predetermined data, either an unacknowledged mode radio link control ciphering error detection and recovery mechanism or a packet data convergence protocol ciphering error detection and recovery mechanism to the at least one radio link control service data unit.

2. A method according to claim 1, wherein the predetermined data has the same form as a packet data convergence protocol header.

3. A method according to claim 1, wherein the predetermined data is inserted into a header part of the at least one radio link control service data unit.

4. A method according to claim 1, wherein the predetermined data is inserted into a new field of at least one radio link control protocol data unit generated from at least a first part of the at least one radio link control service data unit.

5. A method according to claim 4, wherein the new field comprises a new parity field added to said at least one radio link control protocol data unit.

6. A method according to claim 4, wherein the new field is added into the at least one radio link control protocol data unit next to user data of the at least one radio link control protocol data unit.

7. A method according to claim 4, wherein the new field is added into the at least one radio link control protocol data unit next to a length indicator field of the at least one radio link control protocol data unit.

8. A method according to claim 1, comprising generating a plurality of radio link control protocol data units from the at least one radio link control service data unit,
wherein the predetermined data is inserted into a first radio link control protocol data unit in the plurality of radio link control protocol data units.

9. A method according to claim 2, comprising configuring a dummy packet data convergence protocol layer to carry out the insertion of the predetermined data having the same form as a packet data convergence protocol header into the at least one radio link control service data unit.

10. A method according to claim 9, wherein the dummy packet data convergence protocol layer is configured in a radio link control entity of the network entity.

11. A method according to claim 1, wherein the at least one radio link control service data unit is associated with an Internet Protocol Multimedia Subsystem (IMS) voice service or a circuit-switched voice communication over High Speed Packet Access (CSoHSPA) service.

12. A method according to claim 1, wherein the predetermined data is defined via radio resource control signalling between network entity and the user equipment.

13. Apparatus for use in enabling ciphering error detection and recovery in a telecommunications network, the apparatus comprising at least one processor and at least one memory including computer program code, the at least one memory and the computer program code being configured to, with the at least one processor, cause the apparatus at least to, at a network entity:
insert predetermined data into at least one radio link control service data unit; and
transmit the at least one radio link control service data unit comprising the predetermined data to a user equipment in the network,
whereby the user equipment is able to apply, on the basis of the predetermined data, either an unacknowledged mode radio link control ciphering error detection and recovery mechanism or a packet data convergence protocol ciphering error detection and recovery mechanism to the at least one radio link control service data unit.

14. A method of enabling ciphering error detection and recovery in a telecommunications network, the method comprising, at a user equipment:
receiving at least one radio link control service data unit comprising predetermined data; and
applying, on the basis of the predetermined data, either an unacknowledged mode radio link control ciphering error detection and recovery mechanism or a packet data convergence protocol ciphering error detection and recovery mechanism to the at least one received radio link control service data unit.

15. A method according to claim 14, wherein the predetermined data has the same form as a packet data convergence protocol header.

16. A method according to claim 14, wherein the receiving comprises receiving a plurality of radio link control service data units, and
wherein the applying comprises applying the unacknowledged mode radio link control ciphering error detection and recovery mechanism to the plurality of radio link control service data units, the method comprising:
in response to the applying detecting one or more errors in the predetermined data in a given number of consecutive radio link control service data units in the plurality of radio link control service data units, initiating a recovery procedure for a radio link control unrecoverable error.

17. A method according to claim 16, wherein the initiating comprises:
initiating a CellUpdate procedure; or
initiating radio link control or packet data convergence protocol error reporting in the network.

18. A method according to claim 17, wherein initiating the radio link control or packet data convergence protocol error reporting comprises transmitting an uplink radio resource control message to a network entity in the network.

19. A method according to claim 18, wherein the uplink radio resource control message comprises a SignallingConnectionReleaseIndication message.

20. Apparatus for use in enabling ciphering error detection and recovery in a telecommunications network, the apparatus comprising at least one processor and at least one memory including computer program code, the at least one memory and the computer program code being configured to, with the at least one processor, cause the apparatus at least to, at a user equipment:
receive at least one radio link control service data unit comprising predetermined data; and
apply, on the basis of the predetermined data, either an unacknowledged mode radio link control ciphering error detection and recovery mechanism or a packet data convergence protocol ciphering error detection and recovery mechanism to the at least one received radio link control service data unit.
